(19) United States
(12) Patent Application Publication
(10) Pub. No.: US 2012/0075117 A1
(43) Pub. Date: Mar. 29, 2012

(54) ALERT SYSTEM FOR DETECTING AN EMERGENCY VEHICLE

(76) Inventor: James Kaiser, Saint David, AZ (US)

(21) Appl. No.: 12/890,684

(22) Filed: Sep. 26, 2010

(51) Int. Cl. G08G 1/00

(52) U.S. Cl. 340/902

(57) ABSTRACT

An alert system comprising a rearview mirror attached to a windshield of a vehicle, a light connected to a front portion of the rearview mirror, an audible alarm attached to a back portion of the rearview mirror, a processor mounted within the rearview mirror, where the processor activates the light to emit a flash and the audible alarm to emit a sound. A receiver mounted within the rearview mirror wherein the receiver coordinates with the processor to activate the light and the audible alarm when an emergency vehicle comes within a range of detection around the vehicle.

### BACKGROUND OF THE INVENTION

1. Field of the Invention

The present invention relates to a rearview mirror with an alert system to notify a driver when an emergency vehicle is approaching.

2. Description of Related Art

Rules of the road are very important to follow in order to create a safe and efficient manner of traversing the roadways. Those especially important are the rules pertaining to what to do when an emergency vehicle is approaching. Typically, drivers must pull aside when an emergency vehicle is coming to enable the vehicle to pass and quickly get to where they are needed. All of the drivers must follow this rule and cooperate with each other and the emergency vehicle drivers to prevent delays or even more risks posed by those not cooperating.

A few major problems arise when people are required to pull aside for emergency vehicles. First, not everyone follows the rule. Some people simply ignore the requirement of pulling aside to allow the emergency vehicles to pass. Any non-conforming driver creates a potentially very dangerous situation if the emergency vehicle slows down or blocks an area where the vehicle must access. Such a situation may be potentially devastating if the non-conforming driver collides with the emergency vehicle at an intersection. Second, not everyone hears the approaching emergency vehicle from within their cars, which is often why individuals do not pull aside. Various circumstances may inhibit hearing the sirens, for example traffic, music or engine noise, which is dangerous for all parties involved.

It would be beneficial in the art to provide a warning system to alert drivers of an approaching emergency vehicle. It would be desirable for the warning system to include a visual and audible alert.

### SUMMARY OF THE INVENTION

In view of the foregoing disadvantages inherent in the prior art, the present invention relates to an alert system comprising a rearview mirror attached to a windshield of a vehicle, a light connected to a front portion of the rearview mirror, an audible alarm attached to a back portion of the rearview mirror, a processor mounted within the rearview mirror, where the processor activates the light to emit a flash and the audible alarm to emit a sound. A receiver mounted within the rearview mirror wherein the receiver coordinates with the processor to activate the light and the audible alarm when an emergency vehicle comes within a range of detection around the vehicle.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

FIG. 1 depicts a perspective view of an alert system in accordance with an exemplary embodiment of the present invention; and

FIG. 2 depicts a backside view of an alert system in accordance with an exemplary embodiment of the present invention.

Like reference numerals refer to like parts throughout the description of several views of the drawings.

### DETAILED DESCRIPTION OF THE DRAWINGS

The present invention relates to a rearview mirror with an alert system to notify a driver when an emergency vehicle is approaching. The alert system may include a receiver placed within a rearview mirror to detect a signal from the approaching emergency vehicle. Once the signal is detected, a processor within the rearview mirror activates a light and an audible alarm to notify the driver that an emergency vehicle is within a predetermined distance. The alert system notifies drivers of the approaching emergency vehicles to allow them to be more cautious of their surroundings.

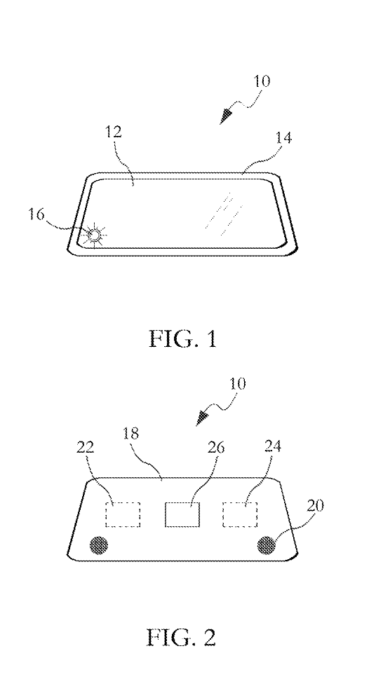

Turning now descriptively to the drawings, referring to FIG. 1, a perspective view of an alert system (10) is shown in accordance with an exemplary embodiment of the present invention. The alert system (10) may comprise a body (14) and a mirror (12). The body (14) and mirror (12) are a rearview mirror in a vehicle. A plurality of vehicles may utilize the alert system (10) including cars, trucks, SUVs, busses, RVs and the like. The body (14) and mirror (12) may be mounted to the windshield, in locations directly visible to ensure a driver may view objects behind or beside the vehicle. In a corner of the mirror (12) a light (16) may be built into or cut out of the glass. FIG. 1 illustrates the light (16) in the lower left corner but the light (16) may be mounted in any of the other three corners, along the sides or along the top or bottom edges. Preferably the light (16) should not be mounted in the center of the mirror (12) for safety concerns in case of blocking or obstructing objects necessary to be seen in the mirror (12). The light (16) may include an LED, an incandescent or a fluorescent light. The light (16) may be connected to a processor (shown as 22 in FIG. 2) which powers the light (16) to flash when activated by an emergency vehicle, such as an ambulance, fire truck or police car. The flash may increase in speed depending on the proximity of the emergency vehicle to the processor. When the emergency vehicle is far away the flash may shine at steady increments and then increase in frequency as the emergency vehicle comes closer, until finally the light has a strobe like effect when the emergency vehicle is within a predetermined distance to the processor.

Referring now to FIG. 2, a backside view of the alert system (10) is shown in accordance with an exemplary embodiment of the present invention. The alert system (10) includes a back panel (18) of the body (14). The back panel (18) may contain the various components of the alert system (10) within the rearview mirror. Along a lower portion of the back panel (18) may be an audible alarm (20). The audible alarm (20) may be one or more speakers or buzzers which emit a sound when triggered by the processor (22). Along a side of the body, a volume control may be attached to enable the driver to increase or decrease the volume of the sound coming from the audible alarm (20). Located in a central portion of the back panel (18) may be an attachment means (26) to mount the alert system (10) against the windshield. The attachment means (26) may be a ball joint socket, suction cup, sticky pad or another commonly used method to place the rearview mirror onto a flat surface such as a windshield.

The processor (22) and a receiver (24) may be built within the body, and held securely after closing the back panel (18). The receiver (24) may receive a signal or detect a sound from an approaching emergency vehicle. The signal may be a radio frequency emitted by the emergency vehicle, or if the emergency vehicle is not equipped with a radio frequency emitting device, the receiver may detect the sound from the sirens mounted on the emergency vehicles. A range of detection around the emergency vehicle may alert the alert system (10) when the emergency vehicle comes within the range. The range of detection may extend out to about 300-400 yards from the vehicle. After the receiver (24) intercepts the signal it may coordinate with the processor (22) to activate the light and the audible alarm (20). Once the light and audible alarm (20) are activated, the light may begin to flash and the audible alarm (20) may sound. As the emergency vehicle approaches, the frequency of the flashes and sounds may increase to inform the driver that the emergency vehicle is getting closer and that the driver should pull over.

In one exemplary embodiment, a sensor may be installed within the engine of the vehicle to detect whether or not the brakes in the vehicle are depressed after the alarm (20) has been triggered. Initially the processor may activate the light and the audible alarm when the emergency vehicle comes within the range of detection, which in turn the light will flash for a few seconds, for example 3-5 seconds. If the brakes are not depressed within a predetermined amount of time the light may flash again for another few seconds or until the brakes are pressed and the vehicle slows. The processor may continue to activate the light to flash until the brakes are pressed or the emergency vehicle leaves the range of detection. After the emergency exits the range of detection, the system may reset in case another emergency vehicle is detected.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An alert system for detecting the presence of an emergency vehicle comprising:
a rearview mirror secured within a vehicle;
a light connected to a front portion of said rearview mirror;
an audible alarm attached to a back portion of said rearview mirror;
a processor mounted within said rearview mirror, where said processor activates said light to emit a flash and said audible alarm to emit a sound; and
a receiver mounted within said rearview mirror wherein said receiver coordinates with said processor to activate said light and said audible alarm when an emergency vehicle comes within a range of detection around said vehicle.

2. The alert system of claim 1, wherein said processor activates said light to flash and said audible alarm to sound at an increasing interval as said emergency vehicle gets closer to said vehicle.

3. The alert system of claim 1, wherein said processor receives a signal from a sensor within an engine of said vehicle to detect when the brakes are depressed.

4. The alert system of claim 3, wherein said processor activates said light for a few seconds and continues to activate said light until either said brakes are depressed or said emergency vehicle leaves said range of detection.

5. The alert system of claim 4, wherein after said emergency vehicle leaves said range of detection, said alert system resets.

6. The alert system of claim 1, wherein said range of detection extends to 300 yards around said vehicle.

7. The alert system of claim 1, wherein said receiver detects a radio signal from said emergency vehicle to coordinate with said processor to activate said light and said audible alarm.

8. The alert system of claim 1, wherein said receiver detects a sound emitted from said emergency vehicle to coordinate with said processor to activate said light and said audible alarm.
